(19) United States
(12) Patent Application Publication
(10) Pub. No.: US 2011/0200830 A1
(43) Pub. Date: Aug. 18, 2011

(54) WATERBASED FORMALDEHYDE FREE ADHESIVES

(76) Inventors: Ronald Tennebroek, Waalwijk (NL); Gerardus Cornelis Overbeek, Waalwijk (NL); Saskia Carolien Van Der Slot, Waalwijk (NL); Mourad Aabich, Waalwijk (NL); Marcel Zambeek, Waalwijk (NL)

(21) Appl. No.: 13/054,071

(22) PCT Filed: Jul. 14, 2009
(86) PCT No.: PCT/EP2009/058988

§ 371 Date: Apr. 14, 2011

(30) Foreign Application Priority Data
Jul. 14, 2008 (EP) 08160329.2

(51) Int. Cl. B32B 7/12; C09J 175/12; C09J 133/14; C09J 133/12; B32B 27/40; B32B 37/12; B32B 38/00

(52) U.S. Cl. 428/423.1; 528/61; 525/127; 525/128; 156/221; 156/331.7

(57) ABSTRACT

There is described a formaldehyde-free laminating adhesive, optionally the with less than 3% by weight of co-solvent(s), the adhesive comprising: (I) a polyurethane that comprises from 30% to 65% by weight of hard segments, the polyurethane being obtained and/or obtainable from a first polyurethane dispersion (PUD) comprising the reaction product of (A) an organic isocyanate and (B) at least one chain extender reacting in a respective stoichiometric ratio (NCO to NCO reactive group) from 1:1 to 1:2.5 and; optionally the NCO reactive group(s) of the chain extender comprises one or more hydrazinyl-like group(s) (denoting isocyanate reactive groups selected from the group comprising, preferably consisting of: —NRNR₂ (hydrazinyl groups); —CONRNR₂ (hydrazidyl groups), —NRCONRNR₂ (semicarbazidyl groups); and —ONR₂ (oxyamine groups), where each R is independently selected from H or C₁₋₁₀hydrocarbo); and (II) optionally a second polymer obtained and/or obtainable from a polymer precursor comprising at least one unsaturated moiety, preferably an ethylenically unsaturated group, and where optionally the second polymer may be iminated; with the provisos that: (α) when the first polyurethane does not comprise hydrazinyl-like group(s) then the second polymer is iminated; and (β) when the second polymer is un-iminated or is absent then the first polyurethane comprises hydrazinyl-like group(s). These adhesives may be used to adhere surface veneers to wood and/or to laminate the layers within plywood.

The present invention relates to polyurethane compositions, processes for preparing them; the use of such compositions as binders and/or laminating adhesives to prepare composite materials and/or shaped articles and articles laminated or bound with the compositions.

Adhesives containing urea and melamine formaldehyde resins are commonly used to prepare laminated wood products as they bind strongly to wood. However products made with these adhesives emit formaldehyde and this is undesirable for environmental and health reasons. Many countries will soon introduce rules to oblige manufacturers to reduce and eventually eliminate formaldehyde emissions.

Polyurethane compositions do not emit formaldehyde and have been used to produce adhesives for many applications, some examples of which are described in the applicant's patent application WO 06/097318 (for example, see page 1, lines 6 to 12). However current polyurethane adhesives are less satisfactory than urea and melamine formaldehyde resins as laminating adhesives. Improved adhesives that are free of formaldehyde, bind strongly to wood fibres under wet conditions and/or have good fatigue resistance are still desired.

The applicant has discovered certain polyurethane compositions that solve some or all of the problems described herein.

Therefore broadly according to the present invention there is provided a formaldehyde-free laminating adhesive, where the adhesive comprises:

(I) a polyurethane that comprises from 30% to 65% by weight of hard segments, the polyurethane being obtained and/or obtainable from a first polyurethane dispersion comprising the reaction product of:

(A) an isocyanate functional pre-polymer and

(B) at least one chain extender

where
(a) the pre-polymer (A) and the chain extender (B) react in a respective stoichiometric ratio of isocyanate to isocyanate reactive group of from 1:1 to 1:2.5 and;
(b) the chain extender(s) comprises one or more isocyanate reactive group(s) that do not react with the isocyanate functional pre-polymer (A) in step (a) and thus will comprise part of the first polyurethane whether before or after dispersion;
   and
(c) optionally the isocyanate reactive group(s) of the chain extender comprise one or more hydrazinyl-like group(s) as defined herein; and

(II) optionally a second polymer obtained and/or obtainable from a polymer precursor comprising at least one unsaturated moiety, preferably an ethylenically unsaturated group, and where optionally the second polymer may be iminated;

with the provisos that:
(α) when the first polyurethane dispersion does not comprise hydrazinyl-like group(s) then the second polymer is iminated; and
(β) when the second polymer is un-iminated or the second polymer is absent; then the first polyurethane comprises hydrazinyl-like group(s).

The laminating adhesives of the invention may be used to prepare any suitable laminates. For example they may adhere surface layers (such as wood veneers) to substrates (such as wood products) and/or may adhere one or more layers (inlcuding interior layers) to form sandwich type structures such as plywood.

It is undesirable that a laminating adhesive contains significant amounts of co-solvents (such as volatile organic compounds, VOC), as such solvents will gradually evaporated from the laminate over time, causing odours and toxic fumes. Large amounts of residual solvent in a laminate also presents problems when disposing of waste laminate materials (during manufacturer or use) as typically these are burnt.

Therefore in a particularly preferred aspect of the invention the laminating adhesives comprise less than 3%, more preferably less than 1% by weight of co-solvent(s) (based on the total weight of the adhesive). Most preferred adhesives are substantially-free, in particular completely-free of co-solvents. Usefully no co-solvent is used to prepare the laminating adhesive, so it does not have to be removed later. Those undesirable co-solvents such as VOC are well known to those skilled in the art, and include organic compounds that have a sufficiently high vapour pressure at room temperature to be present in the air in an amounts to cause a nuisance. It is particular preferred that the compositions of the invention are free of N-methyl pyrrolidone (NMP).

The first polyurethane dispersion (PUD) may be treated with a first agent comprising one or more isocyanate reactive group(s) in an amount where the isocyanate group(s) are or not in excess to modify the molecular weight of the polymer and/or to introduce suitable functional groups (such as hydrazine like groups) thereon.

To modify molecular weight the first agent may be a chain extension agent and/or a chain terminator and/or water. Although water may react with isocyanate groups it conventionally is not considered a chain extender or chain terminator, although as used in the process of the present invention may or may not perform a similar function. All values for amounts (e.g. weight %) of chain extender and/or chain terminator provided herein are calculated excluding water.

To introduce functionality the first agent may be a hydrazine-like agent, and preferably the functionality is added to improve the adhesive and/or other properties of the resultant polyurethane in the adhesive compositions of the invention.

Preferably the first agent is both a chain extension agent and/or a chain terminator and also introduces functionality into the polymer and more preferably the first agent is hydrazine like agent.

The treatment may be one or more steps and may be simultaneous and/or sequential to formation of the first PUD such that either the polyurethane reacts before it is substantially dispersed and/or the polyurethane reacts in the dispersion (e.g. as the first PUD) to form a second PUD which may be used in the present invention as a substitute for to the first PUD.

Without wishing to be bound by any theory, in various embodiments of the present invention the process may be described as follows.

The isocyanate functional pre-polymer may be dispersed in water and then reacted with a chain extension agent (such as polyamine, e.g. a diamine) to achieve high molecular weight. Although typically water is present in excess, the reaction between the isocyanate groups and the amine is much faster than the quite slow reaction between isocyanate and water, especially at the low temperatures (<30° C., conveniently <25° C.) at which it is preferred to perform the process of the invention. Where in one embodiment of the invention it is desired to introduce hydrazine-like functionality (such as semi-carbazide groups) onto the urethane, the pre-polymer (dispersed in water) must contain isocyanate groups (for example those isocyanate groups which have not reacted with the chain extension agent and/or water). Therefore during or after the isocyanate pre-polymer has been dispersed one can add a stoichiometric excess of a hydrazine-like agent (such as and/or a semi-carbazide) to the dispersion to form hydrazine-like (e.g. semi-carbazidyl) groups(s) on the polyurethane (which groups may be usefully attached to the polymer backbone). At the same time the hydrazine-like agent is present in such a small excess that it can react twice, the second time as a chain extension agent to increase the molecular weight (Mw) of the polymer. Thus only a small fraction of the hydrazine-like agent will form hydrazine-like groups (such as semicarbazide groups) on the polyurethane.

In an alternative embodiment of the invention a high molecular weight polyurethane with hydrazine-like functionality (such as semi-carbazide groups) may be obtained as follows. A fraction of the isocyanate groups of the pre-polymer are reacted during or after the pre-polymer has been dispersed with a chain extension agent (such as a polyamine, e.g. diamine, water or even ammonia). Although it is believed ammonia itself can act as a chain stopper, the presence of ammonia also promotes the reaction between isocyanate groups and water. The reaction between a large part of isocyanates and the polyamine proceeds quickly as the isocyanate is in excess and this leads to a rapid increase in molecular weight (Mw). Subsequently (in a later stage) the hydrazine-like agent is added in excess then the remaining smaller fraction of isocyanates will react with the hydrazine-like agent (such as hydrazine and/or semi-carbazide) to form hydrazine-like functionality (such as semicarbazidyl) on the polyurethane.

In a yet other alternative embodiment of the invention the isocycanate functional prepolymer is allowed to react with water during the dispersion step (for example using ammonia, and/by keeping the isocyanate functional pre-polymer in water without adding other chain extension agents (or only small stoichiometric amounts thereof) for a sufficient time and/or at a sufficiently elevated temperature.) This embodiment may be used to obtain hydrazine-like functional (such as semicarbazidyl functional) polyurethane using only very small amounts of the hydrazine-like agent (such as hydrazine and/or a semi-carbazide). Thus for example by first reacting say about 95% of the isocyanate groups of the prepolymer with another chain extender (such as polyamine, e.g. diamine, water and/or ammonia) one might need to only react say the remaining about 5% of the isocyanate groups on the prepolymer with the hydrazine-like agent in excess with respect to the remaining about 5% of isocyanate groups (e.g. hydrazine and/or a semi-carbazide) to achieve a urethane with hydrazine-like (e.g. semicarbazidyl) functionality.

Thus it will be appreciated that when water is taken into account, if it is desired to provide hydrazine-like groups as end groups in the polyurethane used in the present invention an excess (compare to isocyanate) of chain extenders (other than water) are not always necessary, this partly depends on the process conditions. For example adding the chain extender rather late in the process, e.g. from 0 to 10 minutes after the pre-polymer is dispersed may result in a polyurethane which is already partial chain extended by the water, thus reducing the amount of NCO in the system, and hence the ratio of non water chain extender to NCO that may be needed to obtain suitable polyurethanes. Other factors such as pH, temperature etc may also influence the amount of chain extender needed.

In one embodiment of the invention the chain extender comprises at least 0.20 stoichiometric equivalents (with respect to the isocyanate content of the isocyanate pre-polymer (A)) of the isocyanate reactive group, which is preferably one or more hydrazine-like group(s). Greater than 0.20 NCO equivalents is the amount preferred in embodiments when no other chain extender, water, polyamine or ammonia is also reacted with the isocyanate groups.

Another aspect of the invention provides an adhesive as described herein in which (B) the at least one chain extender comprises a total of at least 0.20 stoichiometric equivalents (with respect to the isocyanate content of the organic isocyanate (A)) of plurality of isocyanate reactive group(s) at least one of which is an hydrazinyl-like group;

Some hydrazine-like agent will be needed if hydrazine like end groups are desired, however if a reaction occurs first with water, ammonia and/or polyamines, then less than the 0.2 equivalents of isocyanate of this hydrazine-like agent may be needed (as specified above). Thus in a yet other embodiment of the invention the amount of hydrazine-like agent used (based on equivalents of total isocyanate content) may be greater than 0.01, usefully greater than 0.05, more usefully greater than 0.08; conveniently less than 0.4 more conveniently less than 0.2; advantageously from 0.01 to 0.4 more advantageously from 0.05 to 0.2, most advantageously from 0.08 to 0.2.

A still yet other aspect of the invention provides an adhesive as described herein, in which (B) one chain extender is a hydrazine-like agent comprising a total of less than 0.20 stoichiometric equivalents (with respect to the isocyanate content of the organic isocyanate (A)) of plurality of isocyanate reactive group(s) at least one of which is an hydrazinyl-like group and the isocyanate pre-polymer is reacted (before, during and/or after) chain extension with the hydrazine-like agent with one or more of water, a diamine and/or ammonia.

In another useful embodiment of the invention the first agent is a hydrazinyl-like agent as defined herein, although other isocyanate-reactive agents may be used instead as or as well.

As used herein the term ‘hydrazinyl-like group’ denotes isocyanate reactive groups selected from the group comprising, preferably consisting of: —NRNR₂ (hydrazinyl groups); —CONRNR₂ (hydrazidyl groups), —NRCONRNR₂ (semicarbazidyl groups); and —ONR₂ (oxyamine groups), where each R is independently selected from H or C₁₋₁₀hydrocarbo, usefully H or C₁₋₈hydrocarbyl, most usefully H or C₁₋₄alkyl. Conveniently at least one R on each hydrazinyl-like group is H, more conveniently all R are H. When one or more hydrazinyl-like group(s) are present they may be different hydrazinyl-like group(s) on the same moiety and/or mixtures of different moieties containing the different hydrazinyl-like group(s) on different moiet(ies).

If the chain extender (B) comprises an excess of isocyanate reactive groups (with respect to the isocyanate groups of (A)) the first PUD may not comprise any isocyanate groups and treatment with a first agent may be unnecessary. For example the chain extender may comprise a plurality of hydrazinyl-like groups, such as a poly (hydrazinyl) functional chain extender and/or the chain extender (e.g. hydrazine) may be used in excess.

In a further aspect of the present invention in a yet other embodiment hydrazine-like end groups can be introduced on a polyurethane backbone as described below.

Polyurethane prepolymer may be terminated with NCO groups if a high molecular weight is desired. Preferred prepolymer(s) are di-NCO functional and usually of low molecular weight 1000 to 10000 g/mole, more preferably from 1500 to 5000 g/mol. Conveniently the polyurethane pre-polymer is neutralised and dispersed into water at low temperatures (<30° C.) to prevent significant reaction of the NCO groups with water. Without wishing to be bound by any theory the applicant believes that at such temperature only a very minor part of the NCO groups of the dispersed pre-polymer is reacted or reacting with water. Usefully from 0.9 to 0.95 equivalent stoichiometric amounts of a chain extender can be added to obtain a polymer of high molecular weight.

To provide hydrazine-like end groups on the polyurethane, hydrazine-like compounds can be react with the NCO terminated polyurethane prepolymer, and this can be done in several ways.

For example in a first method excess of hydrazine-like agent may be reacted with the NCO groups of the prepolymer. Without wishing to be bound by any theory it is believed that adding a stoichiometric amount or less of hydrazine-like agent will not lead to hydrazine-like end groups on the polyurethane, which will instead be chain extended such that the molecular weight increases significantly, typically up to 50 to 300 kg/mol. It is also believed that the amount of hydrazine-like compound that can be in excess is limited if a high molecular weight is desired because it is believed that the higher the excess of the hydrazine like agent the lower will be the final molecular weight of the polyurethane.

The isocyanate functional pre-polymer may be dispersed in water and then reacted with a chain extension agent (such as polyamine, e.g. a diamine) to achieve high molecular weight. Although typically water is present in excess, the reaction between the isocyanate groups and the amine is much faster than the quite slow reaction between isocyanate and water, especially at the low temperatures (<30° C., conveniently <25° C.) at which it is preferred to perform the process of the invention. Where in one embodiment of the invention it is desired to introduce hydrazine-like functionality (such as semi-carbazide groups) onto the urethane, the pre-polymer (dispersed in water) must contain isocyanate groups (for example those isocyanate groups which have not reacted with the chain extension agent and/or water). Therefore during or after the isocyanate pre-polymer has been dispersed one can add a stoichiometric excess of a hydrazine-like agent (such as and/or a semi-carbazide) to the dispersion to form hydrazine-like (e.g. semi-carbazidyl) groups(s) on the polyurethane (which groups may be usefully attached to the polymer backbone). At the same time the hydrazine-like agent is present in such a small excess that it can react twice, the second time as a chain extension agent to increase the molecular weight (Mw) of the polymer. Thus only a small fraction of the hydrazine-like agent will form hydrazine-like groups (such as semicarbazide groups) on the polyurethane.

In a second method the NCO groups of the prepolymer may be reacted with other chain extenders such as diamines (but also water and ammonia are possible) and then a small part (on equivalent basis) of hydrazine-like agent is added to achieve a polymer with hydrazine-like end groups as a significant fraction of the NCO groups of the prepolymer have already reacted with the chain extension agents.

With wishing to be bound by any theory, these various embodiments and competing reactions may be illustrated schematically below (where R′ and R″ independently represent any suitable divalent organo residue) and n′ is any suitable integer:

Chain extension with a diamine

OCN—R′—NCO+H2N—R″—NH₂->[—R′—NH(C═O)NH—R″—NH(C═O)—NH—R′—]_{n′}

Reaction with water

OCN—R′—NCO+H₂O->—R′—NH₂+CO₂

The amine so obtained can subsequently react/chain extend with another NCO group:

Reaction with ammonia

OCN—R′—NCO+NH₃->—R′—NH(C═O)NH₂

The group obtained above is fairly un-reactive towards another NCO group in water and therefore acts as a chain stopper. Occasionally ammonia may be used to chain-stop a NCO functional prepolymer, but this is a side reaction when using ammonia as chain extension agent.

So during the process of the invention isocyanate groups can be intentionally reacted with diamines (or also water) and subsequently hydrazine-like compounds can be added to achieve hydrazine-like end groups. This process can be controlled so that polyurethanes with hydrazine-like end groups can be obtained from very small quantities of hydrazine-like compounds

Usefully less than 40% of the isocyanate groups of the pre-polymer may be converted to hydrazine-like end groups. It is believed that for many compositions this proportion of hydrazine-like groups may be sufficient to achieve the desired adhering properties and larger amounts of such end groups may limit the maximum attainable molecular weight of the resulting polyurethane.

In a further aspect of the present invention there is provided a laminated article comprising a one or more laminated layers and a formaldehyde-free laminating adhesive as described herein. Preferred laminated articles comprise a substrate to which a surface layer has been adhered thereto with a laminating adhesive of the present invention. Preferred surface layers comprise veneers such as wood veneers. The substrate any suitable material to which it is desired to attached a surface layer. Preferred substrates comprise; composite materials such as engineered wood (including laminates) and wood. Substrates that contain wood are preferred. It is most preferred that the substrate is wood and/or a wood veneer and the surface layer is a wood veneer.

Conveniently the laminated article(s) of the invention may comprise (in whole or in part) item(s) of furniture (or the like) and/or component(s) thereof, more conveniently may comprise: seating means (e.g. chairs), supporting means (e.g. tables); storage means (e.g. cupboards) and/or components thereof.

A further aspect of the invention provides a method for preparing a laminate comprising the step of:
(a) bonding at least one layer(s) to a substrate using a laminating adhesive of the invention and/or as described herein, to form a laminate.

Advantageously the substrate and/or layer that comprises the laminate of the invention may have a moisture content of from about 5% to about 15% by weight of the material, as it is believed that binders of the present invention may have improved adhesion to wet material.

In a further optional advantage, laminates of the present invention exhibit improved de-lamination resistance in the presence of water compared to laminates prepared with conventional adhesives.

Conveniently the article is heated to a temperature of greater than 90° C., more conveniently greater than 105° C., most conveniently greater than 130° C. Usefully the temperature is less than 200° C., more usefully less than 180° C. Advantageously the temperature is from 90 to 200° C., more advantageously from 105 to 180° C., most advantageously from 130 to 180° C., in particular about 160° C. The article may be cured at these temperatures (i.e. a chemical reaction such as polymerization may take place) and/or may be dried (e.g. to remove water, without a reaction necessarily taking place).

A still yet further aspect of the invention provides a method for preparing a laminated material comprising the steps of:
(a) applying a laminated layer (for example wood or wood veneer) onto a substrate;
(b) binding the layer to the substrate using as the adhesive, a composition of the invention (or similar compositions as described herein);
(c) heating the article from step (a) to form a laminated article, optionally to temperature as given above.
   Steps (a), (b), (c) may be sequential or simultaneous.

Preferably the layer and/or substrate comprise wood. It will be understood that any suitable wood can be used. Conveniently the wood may be selected from oak, beech, nut wood and/or ash.

The laminated layer may be one or more surface layer(s) of a bilayer or trilayer (sandwich) structure. It is preferred that at least one laminated layer is an external layer at the surface of the article, for example a veneer such as a wood veneer. However the layer may also be an internal layer within a multi layered structure (e.g. plywood).

The adhesive may be applied (optionally in separate step) as another layer between the composite material and the laminated layer and/or may comprise the binder already present in the composite material.

Preferably the article is heated at the temperature given herein for a period of at least 2 minutes, more preferably at least 4 minutes, most preferably from 6 to 25 minutes.

Preferably the laminating adhesive is applied to the article in an amount of at least 40 gm⁻², more preferably at least 80 gm⁻², most preferably at least 120 gm⁻².

Conveniently the laminating adhesive is applied to the article in an amount less than 500 gm⁻², more conveniently less than 300 gm⁻². Usefully the laminating adhesive is applied to the article in an amount from 40 to 500 gm⁻², more usefully from 80 to 300 gm⁻², most usefully from 120 to 250 gm⁻².

Preferably the laminating adhesive is applied to the article at a pressure of greater than 20 bar, more preferably greater than 50 bar, most preferably greater than 100 bar. Convenient pressures are from 150 to 350 bar, more conveniently 160 to 250 bar.

Preferably pressure is applied to the article to laminate one or more layers thereon for a period of at least 2 minutes, more preferably at least 4 minutes, most preferably from 6 to 11 minutes.

It is to be noted that the conditions under which the laminating adhesive of the present invention is used to prepare laminated articles such as engineered wood are very different from the conditions used to laminate polymer films where typically a laminating adhesive would be applied at a coat weight of 3.5 gm⁻² and a pressure of 2.76 bar (40 psi) would be applied to the film for 1 to 5 seconds.

Broadly in accordance with a first embodiment of the invention the adhesive comprises:
(I) a polyurethane that comprises from 30% to 65% by weight of hard segments, the polyurethane being obtained and/or obtainable from a first polyurethane dispersion comprising the reaction product of:
   (A) an isocyanate functional pre-polymer and
   (B) at least one chain extender that comprises a total of at least 0.20 stoichiometric equivalents (with respect to the isocyanate content of the prepolymer (A)) of plurality of isocyanate reactive group(s) at least one of which is an hydrazinyl-like group;
      where
      (a) the pre-polymer (A) and the chain extender (B) react in a respective stoichiometric ratio of isocyanate to isocyanate reactive group of from 1:1 to 1:2.5;
      (b) the chain extender(s) B comprises at least 0.20 stoichiometric equivalents (with respect to the isocyanate content of the pre-polymer (A)) of one or more hydrazinyl-like group(s); and
   (II) optionally a second polymer obtained and/or obtainable from a polymer precursor comprising at least one unsaturated moiety, preferably an ethylenically unsaturated group.

Broadly in accordance with a second embodiment of the invention the adhesive comprises:
(I) a polyurethane that comprises from 30% to 65% by weight of hard segments, the polyurethane being obtained and/or obtainable from a first polyurethane dispersion comprising the reaction product of:
   (A) an isocyanate functional pre-polymer and
   (B) at least one chain extender
   where
   (a) the pre-polymer (A) and the chain extender (B) react in a respective stoichiometric ratio of isocyanate to isocyanate reactive group of from 1:1 to 1:2.5;
   (b) the chain extender(s) comprises at least 0.20 stoichiometric equivalents (with respect to the isocyanate content of the pre-polymer (A)) of one or more isocyanate reactive group(s) that have not reacted with the isocyanate groups of the pre-polymer (A) in step (a); and
(II) a second polymer comprising iminated groups; the second polymer obtained and/or obtainable from a polymer precursor comprising at least one iminated unsaturated moiety, preferably an ethylenically unsaturated group.

Broadly in accordance with a third, preferred, embodiment of the invention the adhesive comprises:
(I) a polyurethane that comprises from 30% to 65% by weight of hard segments, the polyurethane optionally obtained from a first polyurethane dispersion comprises the reaction product of:
   (A) a isocyanate functional pre-polymer comprising at least one hydrazinyl-like group (as defined herein); and
   (B) at least one chain extender that comprises a total of at least 0.20 stoichiometric equivalents (with respect to the isocyanate content of the prepolymer (A)) of plurality of isocyanate reactive group(s) at least one of which is an hydrazinyl-like group;
      where
      (a) the prepolymer (A) and the chain extender (B) are reacted in a respective stoichiometric ratio of isocyanate to isocyanate reactive group of from 1:1 to 1:2.5; and
(II) the second polymer comprising iminated groups;

### Composition of the Invention (Amounts of (I) and (II))

In preferred compositions of the invention the weight ratio of polyurethane to the second polymer (where present) is from 10:90 to 99:1, more preferably from 40:90 to 95:5 and most preferably from 65:35 to 90:10.

Preferably polyurethane component (I) is present in an amount of from about 20 to 100%, more preferably from 65% to 90%, most preferably 75% to 85% by the total weight of components (I) and (II).

Preferably the second polymer (II) is present in an amount of from 0 to about 80%, more preferably from 10% to 35%, most preferably 15% to 25% by the total weight of components (I) and (II).

### Polyurethane (I)

The term polyurethane as used herein includes one polyurethane as well as more than one polyurethane, and includes polyurethane copolymers and/or hybrid polyurethanes (such as urethane acrylics).

Without wishing to be bound by any theory it is believed that depending on the choice of component (A) the polyurethane so obtained may form hard or soft segments.

Preferably the hard segment(s) in the polyurethanes described herein may be obtained and/or obtainable from any polyisocyanate and a suitable functional building block usefully of number average molecular weight of less than 500 g/mol.

Conveniently the functional building block comprises at least one, (more conveniently a plurality of), functional group(s) selected from the group consisting of: hydroxy, amine, mercapto and/or combinations thereof on the same moiety, and mixtures of differently functional moieties. Most conveniently the functional building blocks are polyols.

Preferred polyurethanes comprise from 35 to 55%, more preferably 38 to 52% by weight of hard segments.

Advantageous polyurethane dispersions (I) have acid values from 4 to 150 mg KOH/g, more advantageously from 12 to 60 mg KOH/g, most advantageously from 14 to 30 mg KOH/g.

Preferred polyurethanes may have a weight average molecular weight (M_{w}) from 20,000 to 3,000,000 g/mol, more preferably from 50,000 to 2,500,000 g/mol, most preferably from 150,000 to 2,000,000 g/mol and especially preferred 350,000 to 2,000,000 g/mol
Preferred polyurethanes may have a polydispersity (PD=M_{w}, Mₙ) greater than 5; more preferably >17; most preferably >35.

The resultant polyurethane in the composition preferably has a particle size of from 20 to 5000 nm, more preferably of from 25 to 300 nm and most preferably from 30 to 120 nm.

Unless the context indicators otherwise as used herein particle size indicates an average particle size of a specified linear dimension (diameter for approximately spheroidal particles) measured by any suitable technique such as by laser diffraction using a Malvern Zetasizer 3000 HSA.

Methods for preparing polyurethanes are known in the art and are described in for example the Polyurethane Handbook 2^{nd} Edition, a Carl Hanser publication, 1994, by G. Oertel or Szycher's Handbook of Polyurethanes, CRC Press, 1999, by Michael Szycher, and these methods are included herein by reference. The polyurethane may be prepared in a conventional manner by reacting at least one organic polyisocyanate with at least one isocyanate-reactive compound by methods well known in the prior art. Isocyanate-reactive groups include —COOH, —OH, —SH, —NH—, and —NH₂, where —OH, —NH—, and —NH₂ are preferred.

Other examples of suitable methods that may be used analogously to prepare the polyurethanes described herein are given in the applicant's patent application WO 06/097318 (page 9, line 4 to page 13, line 34, which section is incorporated herein by reference).

Other properties of preferred polyurethanes are given in the applicant's patent application WO 06/097318 (page 8, line 12 to line 28, and page 19, line 25 to page 20 line 10, which sections are incorporated herein by reference).

### Prepolymer (A)

Usefully the isocyanate-functional prepolymer (A) may be obtained and/or obtainable by reacting components comprising:
(i) at least one organic polyisocyanate;
(ii) at least one isocyanate-reactive component bearing anionic or potentially anionic water-dispersing groups; and
(iii) at least one isocyanate-reactive component other than component (ii); where component (i) reacts with components (ii) and (iii) in respective stoichiometric ratio of the isocyanate groups of component (i) to total isocyanate reactive groups of components (ii) and (iii) of from 1.2:1 to 5:1:

The term isocyanate-terminated prepolymer as used herein includes one isocyanate-terminated prepolymer as well as more than one isocyanate-terminated prepolymer.

### Component (i) [Organic Polyisocyanate]

Preferably component (I) (polyurethane) comprises 30 to 65%, more preferably 35 to 58% and most preferably 38 to 50% by weight of organic isocyanate (component (i)).

Component (i) comprises any suitable organic polyisocyanate including aliphatic, cycloaliphatic, araliphatic and/or aromatic polyisocyanates. Examples of suitable polyisocyanates are given in the applicant's patent application WO 06/097318 (page 3, lines 5 to 25, which section is incorporated herein by reference).

Other suitable polyisocyanates include ethylene diisocyanate, 1,6-hexamethylene diisocyanate (HDI), isophorone diisocyanate (IPDI), cyclohexane-1,4-diisocyanate, 4,4′-dicyclohexylmethane diisocyanate (4,4′-H12 MDI), p-xylylene diisocyanate, p-tetramethylxylene diisocyanate (p-TMXDI) (and its meta isomer m-TMXDI), 1,4-phenylene diisocyanate, hydrogenated 2,4-toluene diisocyanate, hydrogenated 2,6-toluene diisocyanate, 4,4′-diphenylmethane diisocyanate (4,4′-MDI), polymethylene polyphenyl polyisocyanates, 2,4′-diphenylmethane diisocyanate, 3(4)-isocyanatomethyl-1-methyl cyclohexyl isocyanate (IMCI) and 1,5-naphthylene diisocyanate. Mixtures of polyisocyanates can be used and also polyisocyanates which have been modified by the introduction of urethane, allophanate, urea, biuret, carbodiimide, uretonimine, urethdione or isocyanurate residues. Preferably the polyisocyanate is an araliphatic diisocyanate. More preferably the polyisocyanate is one of isophorone diisocyanate or 4,4′-dicyclohexylmethane diisocyanate. Most preferably the polyisocyanate is isophorone diisocyanate.

### Component (ii) [Anionic and NCO-Reactive]

Preferably component (I) (polyurethane) comprises 2.0% to 20%, more preferably 3 to 11% and most preferably 4 to 7% by weight of component (ii).

Component (ii) may comprise any suitable polyol, preferably a diol, containing anionic or potentially anionic water-dispersing groups.

Preferred anionic water-dispersing groups are carboxylic, phosphoric and/or sulphonic acid groups.

Examples of suitable water dispersing groups are given in the applicant's patent application WO 06/097318 (page 3, line 28 to page 4 line 14 and page 4 line 34 to page 5, line 5 which sections are incorporated herein by reference).

Component (ii) may also comprise compounds include carboxyl containing diols and triols, for example dihydroxy alkanoic acids such as 2,2-dimethylol propionic acid (DMPA) or 2,2-dimethylolbutanoic acid (DMBA), especially DMPA. Other useful compounds include amino carboxylic acids, for example lysine, cysteine and 3,5-diaminobenzoic acid and sulphonic acid derivatives, for example 4,6-diaminobenzene-1,3-disulphonic acid, 5-sodiosulpho-isophthalic acid (SSIPA) and taurine.

Examples of higher molecular weight compounds containing anionic water-dispersing groups include polyether, polyester and polycarbonate polyols containing carboxylic acid groups such as the fumarate polyether glycols described in U.S. Pat. No. 4,460,738, or for example caprolactone modified dihydroxy alkanoic acids.

The anionic or potentially anionic water-dispersing groups may alternatively be introduced by the reaction of an OH-functional polyol or polyurethane with a cyclic anhydride, before, during or after incorporation of this moiety into the final polyurethane.

Preferred compounds containing anionic or potentially anionic water-dispersing groups are DMBA and DMPA.

In the polyurethane dispersion, the anionic water-dispersing groups are preferably fully or partially in the form of a salt. Conversion to the salt form is optionally effected by neutralisation of the polyurethane with a base, preferably during the preparation of the polyurethane

Preferably the weight average molecular weight (Mw) of component (ii) is in the range of from 100 to 10,000 g/mol, more preferably in the range of from 100 to 5,000 g/mol, most preferably in the range of from 120 to 1,000 g/mol and especially in the range of from 125 to 155 g/mol.

Component (iii) [Other NCO-Reactive Species]

Preferably component (I) (polyurethane) comprises 33 to 68%, more preferably 36 to 60% and most preferably 40 to 56% for example 42 to 54% by weight of component (iii).

Component (iii) may comprise suitable cationic water dispersing groups, non-ionic water dispersing groups, cross-linking groups, mixtures thereof or none of these.

One preferred example of a component (iii) is a polyol with a (weight average) molecular weight Mw in the range of from 800 to 3500 g/mol, preferably 800 to 2200 g/mol.

Examples of suitable components (iii) are given in the applicant's patent application WO 06/097318 (page 5, line 6 to page 8, line 14, which section is incorporated herein by reference).

Hydrazindyl-Like Agent [from (I)(b)]

A useful method to obtain polyurethanes with hydrazinyl-like group(s) uses of a combination of a hydrazinyl-like group (s) containing chain extender, in combination with a non-hydrazinyl-like group containing chain extender or chain terminator/stopper. The hydrazinyl-like group may be an isocyanate reactive group is selected from the group consisting of: hydrazinyl (—NHNH₂); hydrazidyl (—CONHNH₂); semicarbazidyl (—NHCONHNH₂); oxyamino (—ONH₂) and/or combinations thereof on the same species. Most preferred functional chain extenders comprise hydrazinyl and/or semicarbazidyl group(s), in particular semicarbazidyl groups.

Usefully the chain extender or chain terminator/stopper may not comprise hydrazinyl-like groups and examples include polyamines, like ethylene diamine, butane diamine, isoporone diamine and the like. Other suitable compounds (such as ammonia and/or water) may also be used in addition to react with the isocyanate to supplement the non-hydrazinyl-like group containing chain extender or chain terminator/stoppers.

Without wishing to be bound by any theory, usefully the above hydrazine-like groups may be considered adhering groups (i.e. may be capable of adhering to the substrate to which they are added).

A disadvantage of using an excess of the compound to react with the polyurethane dispersion (especially if hydrazine) is it is often detectable in the product dispersions which is undesirable. Therefore the non-hydrazinyl group-containing chain extender or chain terminator/stopper is added in an amount which is less than a stoichiometric excess of the isocyanate groups.

Other compounds such as water and ammonia may be added in addition to the hydrazindyl-like agent.

If ammonia is used in addition to the hydrazindyl-like agent, it may be used in an amount of at least 0.2 (preferably least 0.25, more preferably from 0.25 to 3, most preferably from 0.5 to 2 and for example from 0.7 to 2) stoichiometric equivalents of the anionic or potentially anionic water-dispersing groups in component (ii). If ammonia is used, the ratio of isocyanate to total isocyanate-reactive groups may be from 0.5:1 to 1:1.5

Optionally more than 3 stoichiometric equivalents of ammonia could be added in one or more separate additions for example during the preparation and as well as after the preparation of the polyurethane to provide for better dispersion stability (but only if the excess is added after dispersion). Any remaining anionic or potentially anionic water-dispersing groups may be neutralised with an amine or an inorganic base. Up to 2 stoichiometric equivalents of an additional amine may be used. Suitable amines include tertiary amines, such as for example triethylamine, dimethyl butyl amine or N,N-dimethyl ethanolamine. Triethylamine however, is known to have less favourable toxicological properties. Suitable inorganic bases include alkali hydroxides and carbonates, for example lithium hydroxide, sodium hydroxide, or potassium hydroxide. A quaternary ammonium hydroxide, for example ⁺N(CH₃)₄(OH), can also be used. Generally a base is used which gives counter ions that may be desired for the composition. For example, preferred counter ions include Li⁺, Na⁺, K⁺, NH₄⁺ and substituted ammonium salts.

More usefully the ratio of the components (i), (ii) and (iii) may be further defined as follows:

a first ratio (NCO of component (i) to the total of NCO reactive components ((ii)+(iii)) being from 1.2:1 to 5:1; preferably 1.5:1 to 3:1, more preferably 1.7:1 to 2.5:1.

### Chain Extender (B)

The term chain extender as used herein denotes a species that comprises one or more active-hydrogen or other similarly reactive groups that react with isocyanate groups on the polymer, pre-polymer and/or polymer precursor to length the chain thereon.

Preferred chain extenders (B) comprise hydrazinyl-like groups as defined herein. Chain extenders may comprise combinations of different hydrazinyl-like groups on the same moiety and/or mixtures of different moieties containing different hydrazinyl-like groups thereon.

More preferred hydrazinyl-like groups are: selected from the group consisting of: —NHNH₂ (hydrazinyl); —CONHNH₂ (hydrazidyl), —NHCONHNH₂ (semicarbazidyl); and —ONH₂ (oxyamine), most preferably hydrazinyl and/or semicarbazidyl.

Preferably the chain extender (B) is present in an amount of from about 0.1% to about 12%, more preferably from 0.3% to 10%, most preferably 0.4% to 2.5% by the total weight of components (A) and (B).

Examples of suitable hydrazinyl-like groups include radical substituted derivatives of azines, substituted hydrazines such as, 1,6-hexamethylene-bis-hydrazine, carbodihydrazine, hydrazides of polycarboxylic acids and sulphonic acids such as adipic acid mono- or dihydrazide, succinic acid dihydrazide, oxalic acid dihydrazide, isophthalic acid dihydrazide, tartaric acid dihydrazide, 1,3-phenylene disulphonic acid dihydrazide, omega-amino-caproic acid dihydrazide, citric acid trihydrazide, 1,2,4-butane tricarboxylic acid trihydrazide, hydrazides made by reacting lactones with hydrazide such as gamma-hydroxylbutyric hydrazide, bis-semicarbazide and bis-hydrazide carbonic esters of glycols, and/or semicarbazides derived from the reaction of polyisocyanates with an excess of hydrazine (optionally but less preferred followed by reaction with ketones such as acetone to form the corresponding semicarbazones).

### Second Polymer

The second polymer (II) may be obtained from any suitable unsaturated monomer.

Preferred second polymers are vinyl polymers and/or (meth)acrylic polymers.

Conveniently the second polymer has a weight average molecular weight (measured conventionally) of greater than 5 kgmol⁻¹, more conveniently greater than 15 kgmol⁻¹, most conveniently greater than 250 kgmol⁻¹.

Usefully the second polymer has a weight average molecular weight (measured conventionally) of less than 6000 kgmol⁻¹, more usefully less than 1500 kgmol⁻¹, most usefully less than 900 kgmol⁻¹.

Advantageously the second polymer has a weight average molecular weight (measured conventionally) from 5 to 6000 kgmol⁻¹, more advantageously from 15 to 1500 kgmol⁻¹, most advantageously from 250 to 900 kgmol⁻¹.

Conveniently the second polymer has a T_{g} (measured by DSC) of less than 50° C., more conveniently less than 20° C.

Usefully the second polymer has a T_{g} (measured by DSC) of greater than minus 50° C., more usefully greater than minus 25° C.

Advantageously the second polymer has a T_{g} (measured by DSC) from −50° to 50° C., more advantageously from −25° to 20° C.

Other examples of suitable polymers (II) obtained and/or obtained from an unstaturated polymer precursor may be any of those described, obtained and/or obtainable from the monomers in the applicant's patent application WO 06/097318 that are consistent with the parameters herein (page 14, line 1 to page 17, line 34, which section is incorporated herein by reference).

The proportion of vinyl monomer used as a reactive diluent for the isocyanate-terminated prepolymer preparation is preferably from 0 to 95%, more preferably from 0 to 50%, most preferably from 5 to 35% by weight of the total weight of polyurethane and in situ prepared vinyl polymer.

The vinyl polymer (in situ or separately prepared) may be a sequential vinyl polymer. If the vinyl polymer is a sequential vinyl polymer, then preferably there are at least two Tg's where the difference between the two Tg's is at least 40° C., more preferably at least 55° C. If the vinyl polymer is a sequential vinyl polymer, then preferably at least 40 wt % of the vinyl polymer has a Tg between −30 and 50° C. and more preferably between −20 and 15° C. If the vinyl polymer is a blend of different vinyl polymers, then preferably 30 to 90 wt % of the vinyl polymers has a Tg≦25° C. and 10 to 70 wt % of the vinyl polymers has a Tg≧45° C. and more preferably ≧55° C.

Preferably where present the second polymer is obtained and/or obtainable from a (meth)acrylate polymer precursor. Conveniently the (meth)acrylate monomer(s) are present in an amount greater than 40%, more conveniently greater than 60% most preferably greater than 80% by total weight of the monomers used to prepare the second polymer.

Preferably the total amount of polyurethane to vinyl polymer (in situ or separately prepared) solids weight ratio is in the range of from 40:90 to 99:1, more preferably 60:40 to 95:5, most preferably 70:30 to 90:10.

In further embodiment of the present invention the aqueous polyurethane composition of the present invention comprises a separately prepared vinyl polymer in polyurethane to vinyl solids ratio in the range of from 70:30 to 95:5; wherein the vinyl polymer has a Tg in the range of from 0 to 50° C. and is prepared from vinyl monomers selected from the group comprising of methyl methacrylate, ethyl (meth)acrylate, butyl (meth)acrylate, styrene, (meth)acrylic acid and mixtures thereof.

To improve mechanical and/or adhesive properties of the compositions herein, functional groups capable of cross-linking (for example as described in WO 06/097318) may be used without a corresponding group in the composition so that they have not yet reacted.

### COOH Functional Polymers

In a further optionally embodiment of the invention the second polymer (component (II) may comprise co-polymerisible carboxy groups. The optional carboxy groups are preferably present in an amount of from 0.5 to 10%, more preferably from 1 to 7%, most preferably from 2 to 5% by weight of the relevant polymer. These carboxylic functional groups may optionally be iminated as described below.

### Imination

In one embodiment of the invention, the second polymer (e.g. vinyl polymer) may additionally bear amino functional groups. These are preferably prepared from carboxyl-functional precursor polymer(s) (for example introducing carboxy groups therein by using ethylenically unsaturated acid functional polymer precursor(s) such as acrylic acid or methacrylic acid) and subsequently converting at least a proportion of these carboxyl groups to amino groups (as part of amino ester groups) by reaction with an suitable iminating reagent such as an alkylene imine and/or a cyclic imine, more preferably a azirdine and/or C₁₋₆alkylene imine for example ethylene imine and/or propylene imine.

Conveniently the amount of iminating agent used is such that the molar ratio of imine groups of the iminating agent to total carboxy groups of the polymer(s) (before imination) is greater than 0.2, more conveniently greater than 0.4, most conveniently greater than 0.55.

Usefully the amount of iminating agent used is such that the molar ratio of imine groups of the iminating agent to total carboxy groups of the polymer(s) (before imination) is less than 1.6, more usefully less than 1.2, most usefully less than 0.95.

Preferably the amount of iminating agent used is such that the molar ratio of imine groups of the iminating agent to total carboxy groups of the polymer(s) (before imination) is from 0.2 to 2.5, more preferably 0.2 to 1.2, most preferably 0.3 to 0.9.

Preferred second polymers have an acid value before imination of from 5 to 50 mg KOH/g.

Preferred iminated polymers are iminated acrylic polymers.

### Tertiary Amines

In a still further embodiment of the invention the composition of the invention may also comprise tertiary amine monomers as monomer diluents and/or as (co)monomers with the other prepolymers and/or monomers described herein. For example said tertiary amines may also be copolymerized to comprise Component (I) (a polyurethane copolymer) and/or Component (II) (an unsaturated copolymer, e.g. acrylic copolymer).

The optional amine monomer is preferably present in an amount of from 0.1 to 20%, more preferably from 2 to 15%, most preferably from 3 to 15%, for example 5 to 12% by weight of the polymer.

Preferred tertiary amines comprise: dimethylaminoethylacrylate and ureido functional monomers

Suitable ureido functional monomers may comprises at least one of the following:

### Ureido Monomers

Preferred ureido monomers comprise at least one polymer precursor(s) of Formula 2

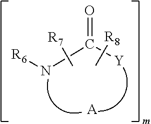

Formula 2, where:
Y denotes an electronegative group,
R₆ is H, OH or an optionally hydroxy substituted C₁₋₁₀hydrcarbo
R₇ is H or a C₁₋₁₀hydrocarbo;
R₈ is a C₁₋₁₀hydrocarbo group substituted by at least one activated unsaturated moiety; and; ether
A represents a divalent organo moiety attached to both the —HN— and —Y— moieties so the -A-, —NH—, —C(═O)— and —Y— moieties together represent a ring of 4 to 8 ring atoms, and R₇ and R⁸ are attached to any suitable point on the ring; or
A is not present (and Formula 2 represents a linear and/or branched moiety that does not comprise a heterocyclic ring) in which case R₇ and R₈ are attached to R₆; and
m is an integer from 1 to 4.

The ring moiet(ies) of Formula 2 are each attached to R₈ and in Formula 1 when m is 2, 3 or 4 then R₈ is multi-valent (depending on the value of m). If m is not 1 R₇ and —Y— may respectively denote the same or different moieties in each ring, preferably the same respective moieties in each ring. R₇ and R₈ may be attached at any suitable position on the ring.

Preferred monomers of Formula 2 comprise, conveniently consist essentially of, those where: A represents a optional substituted divalent C₁₋₅hydrocarbylene; and

Y— is divalent —NR₉— (where R₉ is H, OH, optionally hydroxy substituted C₁₋₁₀hydrocarbo or R₉) or divalent O,

More preferred monomers of Formula 2 comprise those where: m is 1 or 2

—Y— is —NR₉— (i.e. where Formula 2 is attached to R₈ via a ring nitrogen), A represents a divalent C₁₋₃hydrocarbylene; R₆ is H, R₇ is a C₁₋₁₀hydrocarbo; and
R₈ comprises a (meth)acryloxyhydrocarbo group or derivative thereof (e.g. maleic anhydride).

Further suitable ureido monomers of Formula 2 are described in “Novel wet adhesion monomers for use in latex paints” Singh et al, Progress in Organic Coatings, 34 (1998), 214-219, (see especially sections 2.2 & 2.3) and EP 0629672 (National Starch) both of which are hereby incorporated by reference. Conveniently the monomers of Formula 2 may be used as a substantially pure compound (or mixture of compounds) or may be dissolved in a suitable solvent such as a suitable (meth)acrylate or acrylic derivative for example methyl methacrylate.

An example of a suitable ureido functional monomer is that available commercially from Total under trade designation Norsocryl 104.

Ureido functional monomers have been found to be particularly useful for promoting wet adhesion and may preferably be present in an amount of from 0.5 to 8%, more preferably from 1.4 to 6%, by weight of the polymer.

### Surfactant

Adhesives of and/or used in the present invention may also comprise a suitable surfactant, although it is not an essential ingredient,

The total amount of surfactant(s), where present, is in an amount greater than 0.02%, more preferably greater than 0.8% by weight of the total composition. Conveniently the total amount of surfactant is present in an amount less than 8%, more conveniently less than 4%, most conveniently less than 2.2% by weight of the total composition. Advantageously the total amount of surfactant is present in an amount from 0.02% to 8%, more advantageously from 0.8% to 4% by weight of the total composition.

Preferred surfactants (which may be ionic or non-ionic) may comprise poly(alkyleneoxide) moiet(ies), more preferably propylene oxide (PO) and/or ethylene oxide (EO) moiet(ies), most preferably ethylene oxide moiet(ies), in particular where the EO content is at least 5%, for example at least 15%, e.g. >25% by weight of the solids in the total composition.

### Other Properties

Adhesives of and/or used in the present invention may also exhibit a solids content of greater than 28%, more preferably greater than 35%, most preferably greater than 42% by weight of the total composition. Conveniently the solids content is less than 62%, more conveniently less than 54%, most conveniently less than 48% by weight of the total composition. Advantageously the solids content is from 28% to 62%, more advantageously from 35% to 54%, most advantageously from 42% to 48%, by weight of the total composition.

Adhesives of and/or used in the present invention may also exhibit a pH of greater than 6.8 more preferably greater than 7.4. Conveniently the adhesive pH may be less than 10.5, more conveniently less than 9.0, most conveniently less than 8.0. Advantageously the adhesive pH may be from 6.8 to 10.5, more advantageously from 7.4 to 9.0, most advantageously from 7.4 to 8.0. The pH of the adhesive may be determined by any suitable method, such as a pH meter (Probe Mettler-Toledo Inpro 200/Pt1000) the sensor of which may be inserted directly into the adhesive.

Adhesives of and/or used in the present invention may also exhibit an average particle size (measured as a linear dimension, by a suitable method such as that described herein) of greater than 30 microns, more preferably greater than 60 microns, most preferably greater than 80 microns. Conveniently the average particle size is less than 600 microns, more conveniently less than 200 microns, most conveniently less than 140 microns. Advantageously the average particle size is from 30 to 600 microns, more advantageously from 60 to 200 microns, most advantageously from 80 to 140 microns.

Unless otherwise specified the molecular weights given herein were measured by gel permeation chromatography (GPC) using a pulsed field gradient (PFG) linear column with hexafluoroisopropanol (HFIP) as both the solvent and eluent. The column was calibrated in a conventional manner using a poly methyl methacrylate (pMMA) standard.

It will be appreciated that unless stated herein the features described in the different embodiments of the invention herein may be combined together in the same entity or used independently of each other.

The terms ‘optional substituent’ and/or ‘optionally substituted’ as used herein (unless followed by a list of other substituents) signifies the one or more of following groups (or substitution by these groups): carboxy, sulpho, hydroxy, amino, imino, nitrilo, mercapto, cyano, nitro, methyl, methoxy and/or combinations thereof. These optional groups include all chemically possible combinations in the same moiety of a plurality (preferably two) of the aforementioned groups (e.g. amino and sulphonyl if directly attached to each other represent a sulphamoyl group). Preferred optional substituents comprise: carboxy, sulpho, hydroxy, amino, mercapto, cyano, methyl, and/or methoxy.

The synonymous terms ‘organic substituent’ and “organic group” as used herein (also abbreviated herein to “organo”) denote any univalent or multivalent moiety (optionally attached to one or more other moieties) which comprises one or more carbon atoms and optionally one or more other heteroatoms. Organic groups may comprise organoheteryl groups (also known as organoelement groups) which comprise univalent groups containing carbon, which are thus organic, but which have their free valence at an atom other than carbon (for example organothio groups). Organic groups may alternatively or additionally comprise organyl groups which comprise any organic substituent group, regardless of functional type, having one free valence at a carbon atom. Organic groups may also comprise heterocyclyl groups which comprise univalent groups formed by removing a hydrogen atom from any ring atom of a heterocyclic compound: (a cyclic compound having as ring members atoms of at least two different elements, in this case one being carbon). Preferably the non carbon atoms in an organic group may be selected from: hydrogen, phosphorus, nitrogen, oxygen, silicon and/or sulphur, more preferably from hydrogen, nitrogen, oxygen, phosphorus and/or sulphur.

Most preferred organic groups comprise one or more of the following carbon containing moieties: alkyl, alkoxy, alkanoyl, carboxy, carbonyl, and/or combinations thereof; optionally in combination with one or more of the following heteroatom containing moieties: oxy, thio, sulphinyl, sulphonyl, amino, imino, nitrilo and/or combinations thereof. Organic groups include all chemically possible combinations in the same moiety of a plurality (preferably two) of the aforementioned carbon containing and/or heteroatom moieties (e.g. alkoxy and carbonyl if directly attached to each other represent an alkoxycarbonyl group).

The term ‘hydrocarbo group’ as used herein is a sub set of a organic group and denotes any univalent or multivalent moiety (optionally attached to one or more other moieties) which consists of one or more hydrogen atoms and one or more carbon atoms and may comprise one or more saturated, unsaturated and/or aromatic moieties. Hydrocarbo groups may comprise one or more of the following groups. Hydrocarbyl groups comprise univalent groups formed by removing a hydrogen atom from a hydrocarbon (for example alkyl). Hydrocarbylene groups comprise divalent groups formed by removing two hydrogen atoms from a hydrocarbon, the free valencies of which are not engaged in a double bond (for example alkylene). Hydrocarbylidene groups comprise divalent groups (which may be represented by “R2C═”) formed by removing two hydrogen atoms from the same carbon atom of a hydrocarbon, the free valencies of which are engaged in a double bond (for example alkylidene). Hydrocarbylidyne groups comprise trivalent groups (which may be represented by “RC≡”), formed by removing three hydrogen atoms from the same carbon atom of a hydrocarbon the free valencies of which are engaged in a triple bond (for example alkylidyne). Hydrocarbo groups may also comprise saturated carbon to carbon single bonds (e.g. in alkyl groups); unsaturated double and/or triple carbon to carbon bonds (e.g. in respectively alkenyl and alkynyl groups); aromatic groups (e.g. in aryl groups) and/or combinations thereof within the same moiety and where indicated may be substituted with other functional groups

The term ‘alkyl’ or its equivalent (e.g. ‘alk’) as used herein may be readily replaced, where appropriate and unless the context clearly indicates otherwise, by terms encompassing any other hydrocarbo group such as those described herein (e.g. comprising double bonds, triple bonds, aromatic moieties (such as respectively alkenyl, alkynyl and/or aryl) and/or combinations thereof (e.g. aralkyl) as well as any multivalent hydrocarbo species linking two or more moieties (such as bivalent hydrocarbylene radicals e.g. alkylene).

Any radical group or moiety mentioned herein (e.g. as a substituent) may be a multivalent or a monovalent radical unless otherwise stated or the context clearly indicates otherwise (e.g. a bivalent hydrocarbylene moiety linking two other moieties). However where indicated herein such monovalent or multivalent groups may still also comprise optional substituents. A group which comprises a chain of three or more atoms signifies a group in which the chain wholly or in part may be linear, branched and/or form a ring (including spiro and/or fused rings). The total number of certain atoms is specified for certain substituents for example C1 Norgano, signifies a organo moiety comprising from 1 to N carbon atoms. In any of the formulae herein if one or more substituents are not indicated as attached to any particular atom in a moiety (e.g. on a particular position along a chain and/or ring) the substituent may replace any H and/or may be located at any available position on the moiety which is chemically suitable and/or effective.

Preferably any of the organo groups listed herein comprise from 1 to 36 carbon atoms, more preferably from 1 to 18. It is particularly preferred that the number of carbon atoms in an organo group is from 1 to 12, especially from 1 to 10 inclusive, for example from 1 to 4 carbon atoms.

As used herein chemical terms (other than IUAPC names for specifically identified compounds) which comprise features which are given in parentheses—such as (alkyl)acrylate, (meth)acrylate and/or (co)polymer denote that that part in parentheses is optional as the context dictates, so for example the term (meth)acrylate denotes both methacrylate and acrylate.

The substituents on the repeating unit of a polymer and/or oligomer may be selected to improve the compatibility of the materials with the polymers and/or resins in which they may be formulated and/or incorporated for the uses described herein. Thus the size and length of the substituents may be selected to optimise the physical entanglement or interlocation with the resin or they may or may not comprise other reactive entities capable of chemically reacting and/or cross linking with such other resins as appropriate.

Certain moieties, species, groups, repeat units, compounds, oligomers, polymers, materials, mixtures, compositions and/or formulations which comprise and/or are used in some or all of the invention as described herein may exist as one or more different forms such as any of those in the following non exhaustive list:; tautomers (e.g. keto and/or enol forms), conformers, salts, zwitterions, polymeric configurations [such as homo or copolymers, random, graft and/or block polymers, linear and/or branched polymers (e.g. star and/or side branched), cross linked and/or networked polymers, polymers obtainable from di and/or tri valent repeat units, dendrimers, polymorphs (such as interstitial forms, crystalline forms and/or amorphous forms), different phases, solid solutions; and/or combinations thereof and/or mixtures thereof where possible. The present invention comprises and/or uses all such forms which are effective as defined herein.

Other conventional terms from polymer science that are used herein (such as polymer, monomer, oligomer etc) shall have those meanings recommended by IUPAC and as defined in Pure Appl. Chem., Vol. 68, No. 12, pp. 2287-2311, 1996, the contents of which are incorporated herein by reference.

Unless the context clearly indicates otherwise, as used herein plural forms of the terms herein are to be construed as including the singular form and vice versa.

The term “comprising” as used herein will be understood to mean that the list following is non exhaustive and may or may not include any other additional suitable items, for example one or more further feature(s), component(s), ingredient(s) and/or substituent(s) as appropriate.

The term ‘optionally’ as used herein will be understood to mean that the indicated feature may or may not be present.

When amount of ingredients in a composition are given as percentages, it will be appreciate that the total percentage of each component within a composition must sum 100% (allowing for rounding errors).

The terms ‘effective’, ‘acceptable’ ‘active’ and/or ‘suitable’ (for example with reference to any process, use, method, application, preparation, product, material, formulation, compound, monomer, oligomer, polymer precursor, and/or polymers of the present invention and/or described herein as appropriate) will be understood to refer to those features of the invention which if used in the correct manner provide the required properties to that which they are added and/or incorporated to be of utility as described herein. Such utility may be direct for example where a material has the required properties for the aforementioned uses and/or indirect for example where a material has use as a synthetic intermediate and/or diagnostic tool in preparing other materials of direct utility. As used herein these terms also denote that a functional group is compatible with producing effective, acceptable, active and/or suitable end products.

The compositions, materials and articles of this invention are substantially formaldehyde-free, which means preferably they do not comprise any formaldehyde and also do not release any formaldehyde during drying and curing. However very small amounts of formaldehyde (preferably <200 ppm) may be permitted in the formaldehyde-free compositions, materials and articles of the invention.

The applicant has surprisingly found that usefully the polyurethane adhesives of the invention strongly bind to wet materials such as wet wood fibres and therefore can produce laminates which are resistant to water. The laminates of the invention may also have good resistance to fatigue.

The applicant has found that adhesives of the present invention may be particularly suitably for laminating materials where the layers and/or substrate comprise wood. The layers may be interior layers within a laminate for example ply layers in multiple layer plywood and/or may be surface layers for example wood veneers.

Adhesives of the invention may be applied to multiple layers to form multi-layer laminates. For example the adhesive may be located in a very thin layer (sub micron sized) between parallel layers of wood to form a sandwich construction. Such laminates may then be shaped under heat and/or pressure to form shaped articles, which are preferably not flat. For example the laminate may be bend or curved (with respect to the plane of the layers) to form a shaped laminate in which the multi layers are curved (though still substantially parallel to each other).

In one particular preferred embodiment adhesives of the invention may be used to form a multi layer plywood which may be suited to bending under pressure to formed shaped articles such as furniture (e.g. chairs). It has been found that the adhesives of the present invention are particular useful in such applications as they can form plywood which is capable of being bent under pressure and has improved resistance to delaminating.

Particularly preferred laminate wood layers comprise layers of oak, beech, nut wood and ash. However other similar materials may also be suitable for use with the laminating adhesives of the invention. For example other non woven fibrous materials and natural veneers made with natural sources such as plants, and preferably celluosic materials for example lignocellulosic materials, more preferably from renewable sources.

The substrates laminated as described herein may comprise composite materials that comprise any of the materials described above. Preferred substrates comprise woods, composite materials such as engineered woods, analogous and/or derived materials. Engineered wood includes materials in which wood particles (and/or other particles such as those described herein) are compressed together, heated with the binder and optionally extruded to form a composite material. Typically such composites are formed as boards but may be moulded or formed into any desired shape. Engineered woods may then be laminated with a thin layer of wood or veneer of wood or other material (as described herein) to provide the desired aesthetic finish to the laminate. The substrate may itself be a layer as described herein, so for example laminates of the invention may comprise two or more veneer layers or ply layers directly bound together with the adhesive of the invention.

Non limiting examples of engineered wood substrates are for example, chipboard, fibreboard (such as medium density fibreboard (MDF), glued laminated timber, hardboard (such as high density fibreboard (HDF), laminated veneer lumber (LVL), masonite, oriented strand board, parallel strand lumber, particle board, plywood, pressed wood, wafer board and the like. Laminates of the invention may comprise paperboards such as corrugated fibreboards and/or container board as one or more layers.

Many other variations embodiments of the invention will be apparent to those skilled in the art and such variations are contemplated within the broad scope of the present invention.

For example the applicant's patent application WO 06-097318 (the contents of which are hereby incorporated herein by reference) describes polyurethane primer compositions that may also be used as binder and/or adhesives as described herein. The preferred features of the compositions described in WO 06-097318 may also be preferred for compositions of and used in the present invention.

Further aspects of the invention and preferred features thereof are given in the claims herein.

### EXAMPLES

The present invention is now illustrated by reference to the following non limiting examples. Unless otherwise specified, all parts, percentages and ratios are on a weight basis.

### Polymer A

### Preparation of a Non-Iminated Vinyl Polymer

The acrylic polymer was prepared according to U.S. Pat. No. 3,261,799 example 1 (latex A preparation) where a carboxylic polymer latex was prepared with a 53:44:3 composition of 2 ethyl-hexylacrylate:methyl methacrylate:methacrylic acid.

### Polymer B

### Preparation of an Iminated Aminoester Functional Vinyl Polymer

The acrylic polymer was iminated with propylene imine according to U.S. Pat. No. 3,261,799 example 1 with ⅓ of the molar amount of imine required to esterify all the pendant carboxyl groups and the pH of the resulting aminoester polymer latex is adjusted to 10 with ammonium hydroxide.

### Example 1

### Preparation of an Overextended Urethane Polymer Using 0.95 (Stoichiometric Amount, SA) Hydrazine and Neutralised with Ammonia

In a first step a reactor is charged with polyTHF-1000 (1520.4 g; OH number=110 mgKOH/g; pre-melted at 50 [deg.]C) and dimethylolpropanoic acid (DMPA) (168.0 g). The mixture is homogenised to a fine suspension and then isophorone diisocyanate (IPDI) (1111.7 g) is added. The reactor is purged with nitrogen and the contents heated to 50° C. At 50° C., a catalytic amount of tin octoate (0.25 g) is added. The resulting exotherm and additional external heating is used to bring the mixture to a reaction temperature of 90° C. The course of the reaction is monitored by determination of the amount of residual isocyanate groups, by back-titration of the excess of dibutyl amine added to a solution of a sample of the prepolymer in toluene. The reaction temperature is maintained until the NCO content of the resultant polyurethane prepolymer drops to a value below the theoretical value of 6.7% NCO, then cooled to 75° C.

In a second step a second reactor is charged with water (689.1 g), ammonia (neutraliser, 15.8 g, 24% aqueous solution; 1.0 SA relative to the DMPA acid groups of the polyurethane prepolymer) and hydrazine (extender, 72.6 g, 15.2% aqueous solution; 0.95 SA relative to the residual isocyanate groups of the polyurethane prepolymer) and the temperature of the resultant water phase is set at 30° C.

In step three, a heated one litre dropping funnel is used to add the polyurethane prepolymer (500.0 g) prepared in the first step. The polyurethane is added over a period of one hour to the water phase prepared in the second step, while keeping the polyurethane prepolymer temperature at 75° C. The temperature of the water phase is allowed to rise to 39° C. during this dispersion step. In step three, the neutralisation, the chain extension and the dispersion in water are performed simultaneously.

The resulting translucent polyurethane dispersion has a solids content of 40.2%, a pH of 7.2 and a Brookfield viscosity of 605 mPa-s at room temperature (23°+/−2° C.). The concentration of free hydrazine, as determined by HPLC, is around 1 ppm, the detection limit of the equipment used. The polyurethane so obtained may be used and tested as described below.

### Example 2

### Preparation of an Overextended Urethane Polymer Using 1.05 Sa Hydrazine and Neutralised with TEA

The polyurethane prepolymer described in example 1 is used for this example, where a part of the polymer (1100.0 g) is neutralised with triethylamine (0.95 SA relative to the DMPA acid groups of the polyurethane prepolymer) at a temperature of 75° C. (Step 1).

In the second step a reactor is charged with water (650.8 g) and hydrazine (extender, 77.0 g, 15.2% aqueous solution; 1.05 SA relative to the residual isocyanate groups of the polyurethane prepolymer) and the temperature of the resultant water phase is set at 30° C.

In step three, a heated one litre dropping funnel is used to add the neutralised polyurethane prepolymer (500.0 g) prepared in the first step. The polyurethane is added over a period of one hour to the water phase prepared in the second step, while keeping the polyurethane prepolymer temperature at 75° C. The temperature of the water phase is allowed to rise to 39° C. during this dispersion step. In step three the chain extension and the dispersion in water are performed simultaneously.

The resulting translucent polyurethane dispersion has a solids content of 40.6%, a pH of 7.8 and a Brookfield viscosity of 20 Pa-s at room temperature (23°+/−2° C.). The concentration of free hydrazine, as determined by HPLC, is around 1 ppm, the detection limit of the equipment used. The polyurethane so obtained may be used and tested as described below.

### Example 3

### Preparation of a (Non Hydrazine Functional) Urethane Polymer Using 0.85 SA Ethyl Diamine (EDA) and Triethyl Amine (TEA)

The polyurethane prepolymer prepared as described in Example 1 is used for this example, where a part of the polymer (1100.0 g) is neutralised with triethylamine (0.95 SA relative to the DMPA acid groups of the polyurethane prepolymer) at a temperature of 75° C. (Step 1).

In the second step a reactor is charged with water (989.7 g) and ethylene diamine (extender, 18.2 g; 0.85 SA relative to the residual isocyanate groups of the polyurethane prepolymer) and the temperature of the resultant water phase is set at 30° C.

In step three, a heated one litre dropping funnel is used to add the neutralised polyurethane prepolymer (500.0 g) prepared in the first step. The polyurethane is added over a period of one hour to the water phase prepared in the second step, while keeping the polyurethane prepolymer temperature at 75° C. The temperature of the water phase is allowed to rise to 39° C. during this dispersion step. In step three the chain extension and the dispersion in water are performed simultaneously.

The resulting translucent polyurethane dispersion has a solids content of 32.5%, a pH of 7.6 and a Brookfield viscosity of 9700 mPa-s at room temperature (23°+/−2° C.).

The molecular weights (weight average, Mw in kilodaltons/kD) and polydispersity of various polymer examples herein were measured as described herein and are given in the table below:

| Example | Mw/kD | Polydispersity |
|---|---|---|
| Ex 1 | 368 | 19 |
| Ex 2 | 1149 | 84 |
| Ex 3 | 1542 | 114 |
| Latex A | 2284 | 26 |

### Results:

### Examples 1 to 3

### Polyurethane Polymers

The properties of the polyurethane polymers of the invention (Examples 5 to 7) are evaluated in a conventional tests. For example strength with which these mixtures bind to strips of wood is measured as described herein and the results are given in Table 1 (where the strength is averaged over 2 tests and is quoted to 2 significant figures).

TABLE 1

| | Bond strength | | Neutralising | SA chain |
|---|---|---|---|---|
| | (kN/in²) | Extender | agent | extender |
| Ex 1 | 3.0 | Hydrazine | Ammonia | 0.95 |
| Ex 2 | 4.0 | Hydrazine | TEA | 1.05 |
| Ex 3 | 2.5 | ethyl diamine | TEA | 0.85 |

### Examples 4 to 6

### Non Iminated Mixtures

The hydrazine functional polyurethane polymer Example 6 is combined with non-iminated acrylic latex (Polymer A) in three different ratios (solid to solid). The properties of these non-iminated mixtures (Examples 8 to 10) evaluated in conventional tests. For example strength with which these mixtures bind to strips of wood is measured as described herein and the results are given in Table 2 (where the strength is averaged over 2 tests and is quoted to 2 significant figures).

TABLE 2

| | Bond strength | ‘Ex 2’/‘A’ |
|---|---|---|
| | (kN/in²) | ratio |
| Ex 4 | 3.6 | 80/20 |
| Ex 5 | 3.1 | 50/50 |
| Ex 6 | 2.2 | 20/80 |

### Examples 7 to 9

### Iminated Mixtures

The hydrazine functional polyurethane polymer (Example 6) is combined with iminated aminoester functional latex (Polymer B) in three different ratios (solid to solid). The properties of these iminated mixtures (Examples 11 to 13) are evaluated in evaluated in a conventional tests. For example strength with which these mixtures bind to strips of wood is measured as described herein and the results are given in Table 3 (where the strength is averaged over 2 tests and is quoted to 2 significant figures).

TABLE 3

| | Bond strength | |
|---|---|---|
| | (kN/in²) | ‘Ex 2’/‘B’ ratio |
| Ex 7 | 3.7 | 80/20 |
| Ex 8 | 3.2 | 50/50 |
| Ex 9 | 1.7 | 20/80 |

### Examples 10 to 12

### Non-Hydrazine Mixtures

The non-hydrazine functional polyurethane polymer (Example 7) is combined with iminated aminoester functional latex (Polymer B) in three different ratios (solid to solid) and these iminated mixtures (Examples 14 to 16) are evaluated in conventional test. For example strength with which these mixtures bind to strips of wood is measured as described herein and the results are given in Table 4 (where the strength is averaged over 2 tests and is quoted to 2 significant figures).

TABLE 4

| | Bond strength | |
|---|---|---|
| | (kN/in²) | ‘Ex 3’/‘B’ ratio |
| Ex 10 | 2.7 | 80/20 |
| Ex 11 | 2.6 | 50/50 |
| Ex 12 | 3.2 | 20/80 |

### Comp C (Comparative Example Non-Hydrazine Non-Iminated Mixture)

The non-hydrazine functional polyurethane polymer (Example 7) is combined with non-iminated acrylic latex (Polymer A). The properties of this non-iminated mixture (Comp C) is evaluated in conventional tests. For example strength with which these mixtures bind to strips of wood is measured as described herein and the result is given in Table 5 (where the strength is averaged over 2 tests and is quoted to 2 significant figures).

TABLE 5

| | Bond strength | |
|---|---|---|
| | (kN/in²) | ‘Ex 3’/‘A’ ratio |
| Comp C | 1.5 | 20/80 |

### Test Methods:

Detection of Free Hydrazine with HPLC:

This method involves derivatisation of hydrazine with an excess benzaldehyde to form benzaldehyde hydrazone. The derivative is analysed by High Performance Liquid Chromatography with UV detection and quantified by External Standard method.

HPLC with UV detection at 317 nm, column oven at 40° C. and an injection system capable of injecting 5 □l and utilising 2 ml vials (e.g. Waters Alliance 2690 with Waters 996 PDA, Data acquisition by Waters Empower); RP column (Varian MicroSpher C18 3□, 100×4.6 mm with 10 mm guard column and Guard Pak C18).

### Size Exclusion Chromatography (SEC)

The SEC analyses were performed on a Waters Alliance 2695 (pump, degasser and autosampler) with a Shodex RI-101 differential refractive index detector and Shimadzu CTO-20AC column oven. The eluent was 1,1,1,3,3,3 hexafluoro isopropanol (HFIP) with the addition of 0.2M potassium trifluoro actetate (KTFA). The injection volume was 50 μl. The flow was established at 0.8 ml/min. Two PSS PFG Linear XL columns (Polymer Standards Service) with a guard column (PFG PSS) were applied at a temperature of 40° C. The detection was performed with a differential refractive index detector. The sample solutions were prepared with a concentration of 5 mg solids in 2 ml HFIP (+0.2M KTFA), and the samples were dissolved for a period of 24 hours. Calibration is performed with eleven polymethyl methacrylate standards (polymer standard services), ranging from 500 to 2,000,000 gram/mol. The calculation was performed with Empower Pro software (Waters) with a third order calibration curve. The results are obtained via conventional calibration and the molar masses are polymethyl methacrylate equivalent molar masses (gram/mol).

### Tensile Stress

Tensile stress may be measured by any well known convenient test method(s), for example the test method below may be used.

A test substrate was prepared using the following equipment: beech wood strips, (humidity 5-10%), balance, resin to be tested and heated press and under the following conditions: temperature: 23° C.+/−3° C. relative humidity (RH): 40-70%.

Two wooden strips are coated with in total 0.2 gram of resin on a surface of 1 inch². The resin is equally distributed and bond is made by hand. Then the strips are pressed with heat (105° C.) and high pressure (87 PSI ˜6 bars) in order to make the final bond. The strips are acclimatised for 24 hours in a climate chamber (23° C., 55% RH) and then tested using the following equipment: Instron type 4302 draw bench, test program, separation speed 100 mm/min; load cell 10 kN. The peak force needed to separate the beech wood strips in kN/inch² is reported.

1. A formaldehyde-free laminating adhesive, where the adhesive comprises:
(I) a polyurethane that comprises from 30% to 65% by weight of hard segments, the polyurethane being obtained and/or obtainable from a first polyurethane dispersion comprising the reaction product of:
(A) an isocyanate functional pre-polymer and
(B) at least one chain extender
where
the pre-polymer (A) and the chain extender (B) react in a respective stoichiometric ratio of isocyanate to isocyanate reactive group of from 1:1 to 1:2.5 and;
optionally the isocyanate reactive group(s) of the chain extender comprise one or more hydrazinyl-like group(s) (denoting isocyanate reactive groups selected from the group comprising, preferably consisting of: —NRNR₂ (hydrazinyl groups); —CONRNR₂ (hydrazidyl groups), —NRCONRNR₂ (semicarbazidyl groups); and —ONR₂ (oxyamine groups), where each R is independently selected from H or C₁₋₁₀hydrocarbo); and
(II) optionally a second polymer obtained and/or obtainable from a polymer precursor comprising at least one unsaturated moiety, preferably an ethylenically unsaturated group, and where optionally the second polymer may be iminated;
with the provisos that:
(α) when the first polyurethane does not comprise hydrazinyl-like group(s) then the second polymer is iminated; and
(β) when the second polymer is un-iminated or is absent then the first polyurethane comprises hydrazinyl-like group(s); and where. optionally the adhesive comprises less than 3% by weight of co-solvent(s)

2. An adhesive as claimed in claim 1, in which (B) the at least one chain extender comprises a total of at least 0.20 stoichiometric equivalents (with respect to the isocyanate content of the organic isocyanate (A)) of plurality of isocyanate reactive group(s) at least one of which is an hydrazinyl-like group;

3. An adhesive as claimed in claim 1, in which (B) one chain extender is a hydrazine-like agent and the amount of hydrazine-like agent used (based on equivalents of total isocyanate content) preferably is from 0.01 to 0.4

4. An adhesive as claimed in claim 1, in which (II) the second polymer comprises iminated groups

5. A laminated article comprising a one or more laminated layers and a formaldehyde-free laminating adhesive as claimed in claim 1.

6. A laminated article according to claim 5, which comprises an item of furniture and/or component thereof.

7. A method for preparing a laminate comprising the step of:
(a) bonding at least one layer(s) to a substrate using a laminating adhesive as claimed in claim 1 to form a laminated article.
(b) optionally shaping the laminated article under pressure

8. A method as claimed in claim 5, comprising the steps of:
(i) applying a layer onto a substrate (which substrate may itself be a layer);
(ii) binding the layer to the substrate using the laminating adhesive to form a laminate;
(iii) heating the laminate above 90° C.;
where steps (i) to (iii) may be sequential or simultaneous.

9. A method as claimed in claim 5, where at least one layer is selected from a surface wood veneer and/or single ply of a multi-layer plywood.

10. A method as claimed in claim 5 where the laminating adhesive is applied to the or each layer and/or substrate in an amount of at least 40 gm⁻².
